(19) United States
(12) Patent Application Publication
(10) Pub. No.: US 2003/0103867 A1
(43) Pub. Date: Jun. 5, 2003

(54) Compact diagnostic testing device

(75) Inventors: Richard W. Newman, Auburn, NY (US); Dominick A. Danna, Syracuse, NY (US)

Correspondence Address: WALL MARJAMA & BILINSKI, 101 SOUTH SALINA STREET, SUITE 400, SYRACUSE, NY, 13202, US

(73) Assignee: Welch Allyn, Inc.

(21) Appl. No.: 09/884,224

(22) Filed: Jun. 19, 2001

(51) Int. Cl. G01N 27/00

(52) U.S. Cl. 422/58; 436/149

(57) ABSTRACT

A compact hand-held diagnostic device includes at least one chemical sensing element mounted to an external surface of a substrate, the chemical sensing element being capable of detecting at least one chemical component indicative of a condition of a target and producing an electrical change when said at least one chemical component is detected. The device includes a processor for processing electrical changes produced by the chemical sensing elements into a resulting signal and at least one indicator connected to the processor for indicating the presence of a detected chemical component and in which the chemical sensing element is directly exposed to the target environment without requiring any portion of the environment to first be drawn into the device. The compact device can be used in both medical and industrial applications.

### FIELD OF THE INVENTION

The invention is related to the field of diagnostic fluid or vapor measurement, and more particularly to an extremely compact diagnostic fluid sensing device used for medical and industrial purposes.

### BACKGROUND OF THE INVENTION

Electronic devices are repletely well known for detecting the presence of certain vapors, such as carbon monoxide and carbon dioxide, smoke, etc, in either an industrial or home environment. Likewise, further applications of chemical sensing technology are found in the food processing industry.

To date, there are very few known devices which are utilized for medical applications or similar purposes. In addition most devices of this sort, regardless of the field of use, require a housing which retains at least one chemical sensor in a testing chamber. These devices further include means, such as a pump or other similar mechanism, for inputting a portion of the atmosphere of an intended target into the testing chamber for evaluation by the chemical sensor(s). An example of such a device is described in U.S. Pat. No. 6,234,006 to Sunshine et al. The testing chamber is internally disposed relative to a device housing. Another example found commercially is the Breath Alert Breath Checker manufactured by the Tanika Corporation. Such devices are also described, for example, in U.S. Pat. No. 5,799,102 to Leong, which determines the authenticity of a bank note, and U.S. Pat. No. 5,675,070 to Gelperin in which an array of gas sensors are disposed in a specific testing chamber. The gas sensors of the array can detect predetermined levels of specified chemical components in a fluid mixture and then produce a sensor pattern which can subsequently be analyzed.

It is a further general need to make diagnostic devices as compact as possible, given the space constraints in, for example, a medical office facility yet there is a competing need to make such a device contain adequate sensors and processing hardware in order to identify literally any chemical component of a fluid which might be present in a target atmosphere.

### SUMMARY OF THE INVENTION

It is a primary object of the present invention to provide a compact diagnostic chemical sensing device which overcomes the above-noted disadvantages of the prior art.

It is another primary object of the present invention to provide an extremely compact diagnostic device which incorporates chemical sensors that are capable of determining the presence of a specific chemical component of a fluid in a target atmosphere.

Therefore, and according to a preferred aspect of the present invention, there is provided a compact diagnostic device comprising a substrate, at least one chemical sensing element mounted to said substrate, said at least one chemical sensing element being capable of detecting at least one chemical component of a fluid and producing an electrical change when said at least one chemical component is detected. The device further includes processing means for processing electrical changes produced by said at least one chemical sensing element into a resulting signal, and indicating means connected to said processing means for indicating the presence of the at least one chemical component.

A feature of the described device is that the processing means can include a microprocessor which is provided on the substrate itself along with a display or other form of indicator to provide an all inclusive and extremely compact chemical sensing system. Alternately, the substrate can include a wireless transmitter permitting transfer of electrical changes generated by the chemical sensing elements to a separate remote processor. According to yet another alternate version, the very compact substrate(s) can be directly interconnected to or used in conjunction with a separate remote processor unit to utilize additional processing capability, as needed.

The herein described device can be preferably used in medical applications. For example, the substrate can have a geometry similar to that of a tongue depressor and be positioned directly into an anatomical body cavity, such as the mouth, such that the chemical sensing elements disposed on the substrate are directly exposed to the target environment. Similarly, the device can maintain other configurations to allow placement in relation to other medical targets such as body cavities including the ear, nose, colon, among others, or other areas such as an in vivo portion of skin. Alternately, the diagnostic device of the present invention can be used for certain industrial applications, such as chemical inspection of contained areas such as nuclear reactors or pressure vessels, to determine the nature of chemical fires in fire fighting, and other containers filled with fluids, explosives, bacterial agents, toxic gases and other closed container applications.

According to another preferred aspect of the present invention, there is provided a diagnostic device for determining the condition of a target, said device including a substrate. A plurality of chemical sensing elements are arranged on the exterior of the substrate, each of said chemical sensing elements being capable of detecting the presence of at least one chemical component indicative of the condition of the target and producing an electrical change when said at least one chemical component is detected. The device further includes a processor for processing electrical changes produced by each chemical sensing element into a resulting signal indicative of the presence of said condition and an output for outputting processed resulting signals to a user.

The processor can be located on the substrate itself along with a display to provide an all inclusive sensing instrument. Alternately, the substrate can be configured to transmit electrical signals created by the chemical sensing elements indicative of the presence of a chemical component either through a wired or a wireless connection to a separate processor.

An advantage of the present invention is that an extremely compact diagnostic device is herein described which can include an array of chemical sensing elements directly mounted on a substrate which can be positioned in a target environment without requiring pumps or other similar devices to input the contents of the target environment into a separate testing chamber.

Another advantage of the present invention is that the diagnostic device can handle multiple forms of application/use. For example, the herein described device can include all or some processing capability within the substrate itself. Alternately, a wireless or other form of transmitter can be provided to interconnect the device with a separate processor having additional capability if needed. According to yet another alternate variation, the device can be directly inputted into a separate processor, providing still greater versatility and increasing the efficiency and efficacy of the device, regardless of the complexity of the target environment.

These and other objects, features, and advantages will become apparent from the following Detailed Description which should be read with reference to the accompanying drawings.

### BRIEF DESCRIPTION OF THE DRAWINGS

FIG. 1 is a top perspective view of a diagnostic chemical sensing device in accordance with a preferred embodiment of the present invention;

FIG. 2 is an electrical block diagram of the diagnostic device of FIG. 1;

FIG. 3 is a diagnostic chemical sensing device made in accordance with a second embodiment of the invention including a wireless transfer of data to a remote processor; and

FIG. 4 is a diagnostic chemical sensing device made in accordance with a third embodiment of the present invention.

### DETAILED DESCRIPTION

The following description herein relates to certain embodiments of a diagnostic device used in a particular medical application in which the oral cavity (i.e., the mouth) of a patient is examined in order to determine the presence of disease. It will be readily apparent, however, from the inventive concepts described herein that other medical applications, as well as a significant number of varied industrial uses may also utilize the inventive concepts described herein. Furthermore, the following description uses terms such as “top”, “inner” “outer”, and “exterior”, among others, in order to provide a frame of reference with regard to the embodiment illustrated by the accompanying drawings. These terms, however, are not intended to be severely limiting of the inventive concepts as claimed and should not be so narrowly interpreted.

For purposes of the following discussion, “fluid” is defined as any liquid, gas or vapor.

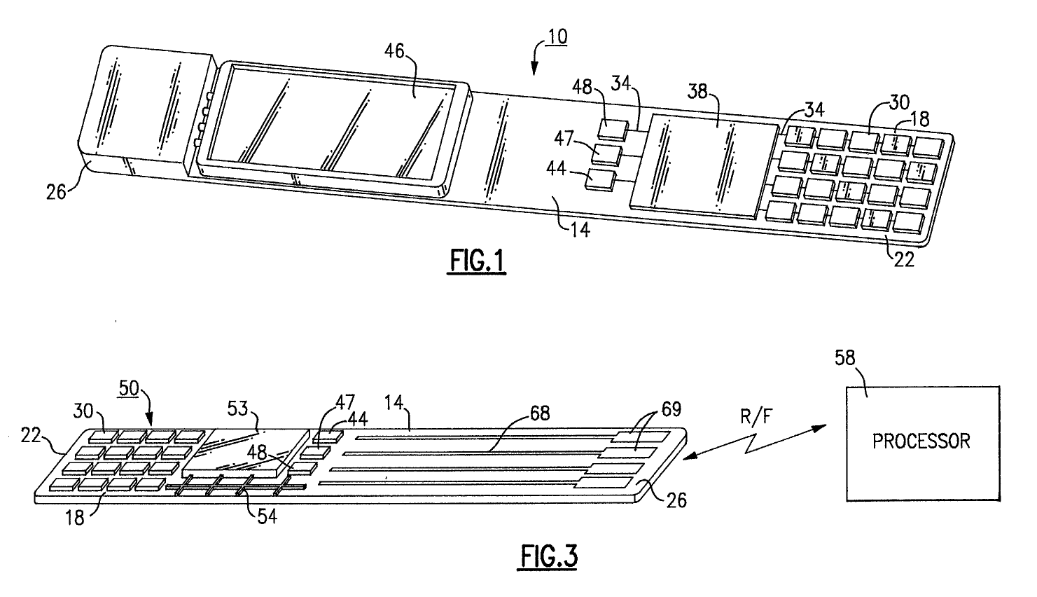

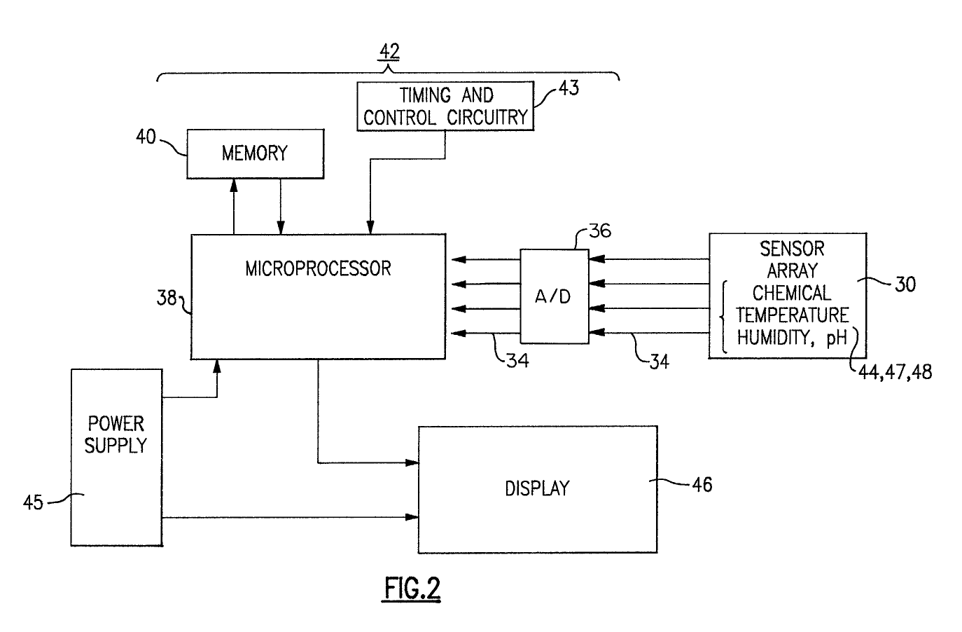

Referring to FIGS. 1 and 2, there is shown a diagnostic chemical sensing device 10 according to a first embodiment. The device 10 is defined by an elongated substantially planar substrate 14, which is fabricated preferably made from any suitable biocompatible material, such as composite, wood, plastic, or ceramic. The substrate 14 according to this embodiment is shaped and sized to resemble a tongue depressor, in order to fit within the mouth of a patient (not shown). It will be readily apparent, however, that the geometry of the device can be varied depending on the application, while still incorporating the inventive concepts described herein.

The substrate 14 of the device 10 includes an exterior surface 18 as well as opposing distal and proximal ends 22, 26, respectively. A plurality or array of chemical sensing elements 30 are mounted onto the exterior surface 18 of the elongated substrate 14 in the vicinity of the distal end 22 by means such as epoxy, glass frit, adhesive, or other means. Alternately, the sensor array 30 can be provided as part of a plug-in electrical module (not shown) having connectors (also not shown) which mount to a mating portion at the distal end of the elongated substrate 14. According to this embodiment, the sensors of the array 30 are miniature polymer gas sensors, such as those manufactured by Cyrano Sciences, Inc. of Pasadena, Calif. or as described in U.S. Pat. No. 5,571,401 to Lewis et al., U.S. Pat. No. 5,882,497 to Persaud et al., U.S. Pat. No. 6,013,229 to Lewis, and U.S. Pat. No. 6,093,308 to Lewis, add sensors the entire contents of each being herein incorporated by reference. It will be readily apparent, however, that other known chemical sensing elements such as organic gas sensors, conductive composites, metal oxide field effect transistors, surface acoustic wave (SAW) sensors, piezoelectric sensors and others, can also be substituted. Each of the sensing elements of the array 30 are capable of detecting a specific fluid (e.g. gas, liquid, or vapor), the presence of which produces an electrical charge. The electrical charge can be resistance, capacitance, transconductance, conductance, voltage, impedance, resonant frequency or other perceivable electrical parameter.

Still referring to FIGS. 1 and 2, a series of electrical traces 34 from each of the sensors of the array 30 extend to a microprocessor 38, having suitable storage memory 40, also provided on the exterior surface 18 of the substrate 14. Preferably, the microprocessor 38 includes certain integrated processing electronics 42 including an analog-digital (A/D) converter 36 as well as suitable timing and control circuitry 43 which is used in conjunction with a reference crystal (not shown), in order to detect the amount of electrical change by each of the sensors of the array 30 for processing, such as comparing to a stored lookup table and then for outputting the results to a compact LCD or other suitable display 46, also provided on the exterior surface 18 of the elongated substrate 14. The device 10 is powered by a set of lithium ion batteries (not shown) or other suitable compact power supply 45, as shown diagrammatically in FIG. 2.

Individual sensors 44, 47, 48 are also mounted in relation to the chemical sensor array 30 to determine temperature, relative humidity, and pH, respectively. The outputs of each of these environmental sensors are also directly connected to the microprocessor and can, for example, be displayed.

In operation, the device 10 is inserted, for example, by placing the distal end of the substrate 14 directly into the mouth of a patient (not shown), with the array 30 of chemical sensing elements being placed in substantial immediate proximity with a target environment. This target environment can include that contained within the mouth itself and also can include those chemical components which may be present in the esophogus, stomach, throat, etc. As noted previously, each of the sensors of the array 30 are manufactured so as to produce an electrical change when a particular chemical component are detected. The electrical changes are then transmitted along the traces 34 to the microprocessor 38 wherein the processing electronics 42 compares the transmitted electrical signals with the stored lookup table and then displays the results of those gases or vapors present in the target atmosphere. Alternately, the display means can indicate the type or amount of chemical in a fluid component which is present, whether bacteria present the presence of metabolytes or other indications depending on the application of the device.

Referring to FIG. 3, a second embodiment of the present invention is herein described. For the sake of clarity, similar parts will be labeled with the same reference numerals.

In this instance, a disease diagnostic device 50 includes an elongated substantially planar substrate 14, also made from a suitable biocompatible material such as composite, wood, ceramic, or plastic. Also and as in the preceding the elongated substrate 14, according to the application for which the device 50 is used, is shaped and sized to closely resemble a tongue depressor.

The elongated substrate 14 includes an exterior surface 18 and opposing distal and proximal ends 22, 26, respectively. A plurality or array of chemical sensing elements 30 are disposed on the exterior surface 18 of the substrate 14 in the vicinity of the distal end 22. According to this embodiment, the sensors of the array 30 are miniature polymer gas sensors, such as those described in those previously incorporated by reference above.

A series of electrical traces 68 from each of the sensors of the array 30 extend to a microprocessor 53 also provided on the exterior surface 18 of the substrate 14. The microprocessor 53 according to this embodiment does contain a storage memory 40, FIG. 2, similar to that described above but not contain processing electronics 42, FIG. 2, though clearly a microprocessor such as previously described in the first embodiment and having suitable processing circuitry could be substituted.

A wireless transmitter, including an RF transmitting antenna 54, is also provided on the substrate 14, each being wired by conventional means to the microprocessor 53 to enable stored values generated by the sensor array 30 to be transmitted to a remote processor 58.

In operation and according to this embodiment, the device 50 is inserted, as previously described, by placing the distal end 22 of the substrate 14 directly into the mouth of a patient, and the array 30 of chemical sensing elements are placed in substantial immediate proximity with a target environment. This atmosphere can include that contained within the mouth itself and also can include those chemical components present in the esophagus, stomach, throat, etc. As noted previously, each of the sensors of the array are manufactured so as to produce an electrical change when at least one particular chemical component is are detected. The electrical changes are then transmitted along the traces 34 to the storage memory 40, FIG. 2, of the microprocessor 53. According to this embodiment, the stored values in memory 40, FIG. 2, can later be transmitted using the RF transmitter and antenna 54 to the separate remote processor 58 having its own processing electronics and display (not shown).

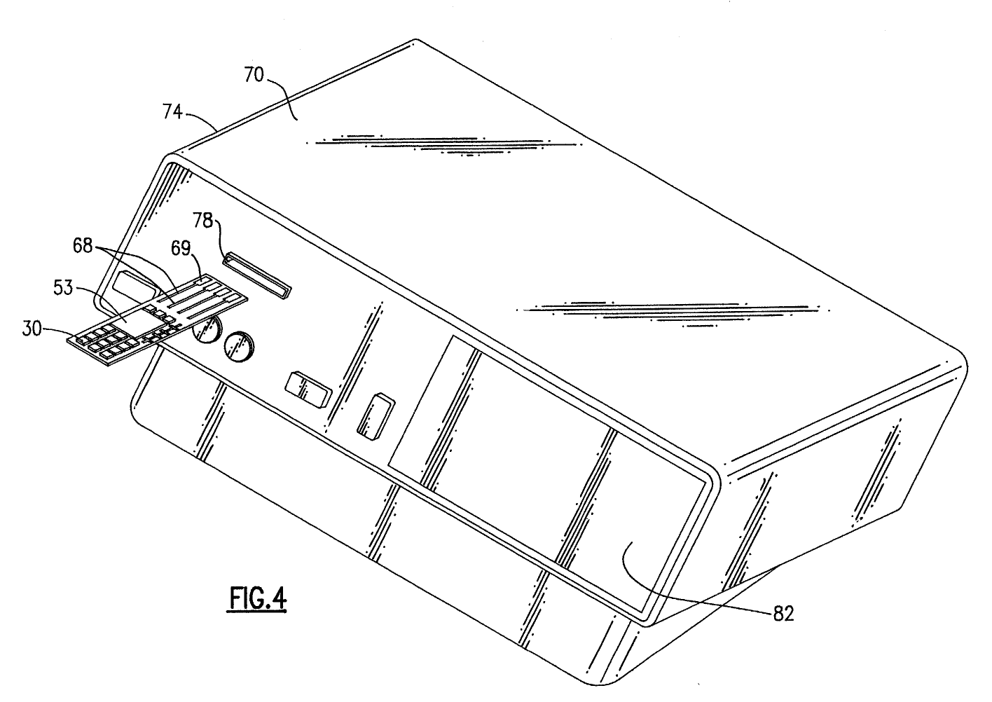

Referring to FIG. 4, a third embodiment of the invention is described. Again and for the sake of clarity, similar reference numerals are used for similar parts. According to this embodiment, an elongated substrate 14, similar to that described in the preceding, can further include a plurality of additional electrical traces 68, each of which extend to corresponding electrical connectors 69 to permit the transmission of stored signals from a disposed chemical sensor array 30 directly into a separate processing unit 70. That is, the proximal end 26 of the substrate 14 can be placed within the confines of an insertion slot 78 of the separate processor unit 70, the processor having contained electronics within a housing 74 for processing the electrical signals generated by the array 30 and a display 82 for displaying specific results, e.g. the presence of at least one specific chemical component indicative of disease. In this instance, the separate processor unit 70 can include greater processing capability and memory to provide a more detailed and complete analysis of a target atmosphere, for example, those having a number or unique combination of possible chemical components present.

It is possible that each of the preceding embodiments could be contain any or all of the described features in combination. For example, the device 50 could include a display 46, FIG. 2, similar to that described in the first embodiment whereby an initial assessment could be made to determine the presence of disease. If additional analysis is required, then the signals from the sensor array 30 could be transmitted, either wirelessly as described in FIG. 3, or through a direct plug-in to a separate processor unit 70, as described in FIG. 4, as needed.

| | |
|---|---|
| 10 | diagnostic device |
| 14 | substrate |
| 18 | exterior surface |
| 22 | distal end |
| 26 | proximal end |
| 30 | array chemical sensing elements |
| 34 | electrical traces |
| 36 | A/D converter |
| 38 | microprocessor |
| 40 | memory—storage |
| 42 | processing electronics |
| 43 | timing and control circuitry |
| 44 | temperature sensor |
| 45 | relative humidity sensor |
| 46 | display |
| 47 | pH sensor |
| 50 | diagnostic device |
| 53 | microprocessor |
| 54 | transmitting antenna |
| 58 | remote processor |
| 68 | electrical traces |
| 69 | electrical connectors |
| 70 | separate processor unit |
| 74 | processor housing |
| 78 | insertion slot |
| 82 | display |

It should be readily apparent that various modifications and variations are possible within the intended scope of the invention to cover several applications covering both medical and industrial uses in which an array of chemical sensors can directly be exposed to a target environment and in which the signals generated from the sensor array can be processes to determine the presence of a predetermined condition or hazard. That is to say, the preceding description is related to a specific medical target, but it should be readily apparent that a varied number of medical and/or industrial targets could be inspected using the compact apparatus herein described.

We claim:

1. A handheld compact diagnostic device comprising:
a substrate;
at least one chemical sensing element mounted to said substrate, said at least one chemical sensing element being capable of detecting at least one chemical component of a fluid indicative of a condition of a target and producing an electrical change when said at least one chemical component is detected;
processor means for processing electrical changes produced by said at least one chemical sensing element into a resulting signal; and
at least one indicator connected to said processor for indicating the presence of a said detected chemical component wherein said chemical sensing element is directly insertable into a target environment.

2. A device as recited in claim 1, wherein said processor means includes at least one processor disposed on said substrate.

3. A device as recited in claim 1, wherein at least one indicator is provided on said substrate.

4. A device as recited in claim 1, including at least one battery for powering said device.

5. A device as recited in claim 1, wherein said processor means includes a remote processor unit having means for receiving said substrate.

6. A device as recited in claim 2, wherein said processor disposed on said substrate includes memory means for storing values of electrical changes produced by said at least one chemical sensing element.

7. A device as recited in claim 6, including transmission means for transmitting stored values to a remote site.

8. A device as recited in claim 7, wherein said transmission means includes wireless transmission means for wirelessly transmitting stored values to said remote site.

9. A device as recited in claim 7, wherein said remote site includes a slot sized for receiving at least a portion of said substrate.

10. A device as recited in claim 5, including a display provided on at least one of said remote processor unit and said substrate.

11. A device as recited in claim 1, wherein said substrate is sized for positioning relative to a medical target.

12. A device as recited in claim 11, wherein said medical target includes at least one body cavity consisting of at least one of the mouth, nose, sinus, ears, rectum, vagina, urinary tract or peritoneum.

13. A device as recited in claim 1, wherein said substrate is sized for positioning relative to an industrial target.

14. A device as recited in claim 13, wherein said industrial target includes at least one of a group of contained areas consisting of pipes, pressure vessels, engines, nuclear reactors, wells, and tanks.

15. A device as recited in claim 1, wherein said substrate is disposable.

16. A hand-held diagnostic device for determining the presence of condition of a target, said device comprising:
a substrate;
a plurality of chemical sensing elements disposed on an external surface of said substrate, each of said chemical sensing elements being capable of detecting the presence of at least one chemical component of a fluid indicative of said condition and producing an electrical change when said at least one chemical component is detected;
processing means for processing electrical changes produced by each chemical sensing element into a resulting signal indicative of the presence of said condition of said target; and
output means for outputting processed resulting signals wherein said substrate is directly insertable into a target environment.

17. The device as recited in claim 15, wherein at least a portion of said processing means is provided on said substrate.

18. The device as recited in claim 16, wherein said processing means includes a microprocessor disposed on said substrate.

19. The device as recited in claim 16, wherein said plurality of chemical sensing elements are exposed directly to fluids present in the mouth of a patient.

20. The device as recited in claim 16, wherein said indicating means are provided on said substrate.

21. The device as recited in claim 16, said device being disposable.

22. The device as recited in claim 16, wherein said processing means includes a remote processor and means for interconnecting said plurality of chemical sensing elements with said remote processor.

23. The device as recited in claim 22, wherein said interconnecting means includes a transmitter provided on said substrate for transmitting signals from said plurality of chemical sensing elements to said remote processor.

24. The device as recited in claim 23, wherein said transmitter is wireless.

25. The device as recited in claim 24, wherein said transmitter is an RF transmitter.

26. The device as recited in claim 24, wherein said transmitter is an IR transmitter.

27. The device as recited in claim 23, wherein said transmitter includes leads extending to one end of said substrate, said remote processor unit including a slot for receiving the end of said substrate having said leads.

28. The device as recited in claim 23, wherein said processing means includes a microprocessor mounted to said substrate, said microprocessor having memory for storing signals produced by said plurality of chemical sensing elements, said microprocessor being connected to said transmitter.

29. The device as recited in claim 16, wherein said output means includes at least one indicator provided on said substrate and at least one battery disposed on said substrate providing an integral device.

30. The device as recited in claim 27, wherein said device is disposable.

31. A method of determining the condition of a target environment, said method including the steps of:
providing a substrate having a plurality of chemical sensing elements disposed on an external surface, said chemical sensing elements being capable of detecting at least one chemical component present in a fluid; and
placing said substrate into the target environment such that said plurality of chemical sensing elements are directly exposed to said target environment.

32. A method as recited in claim 31, wherein said placing step includes the step of placing said substrate into the mouth of a patient.
